(19) United States
(12) Patent Application Publication
(10) Pub. No.: US 2008/0028606 A1
(43) Pub. Date: Feb. 7, 2008

(54) Low stress turbins bucket

(75) Inventors: Poornathresan Krishnakumar, Greenville, SC (US); Joseph A. Weber, Simpsonville, SC (US); J. Tyson Balkcum, Taylors, SC (US)

Correspondence Address: NIXON & VANDERHYE, PC, 901 NORTH GLEBE ROAD, 11TH FLOOR, ARLINGTON, VA, 22203, US

(73) Assignee: General Electric Company, Schenectady, NY (US)

(21) Appl. No.: 11/493,021

(22) Filed: Jul. 26, 2006

(51) Int. Cl. B23P 15/04; B23P 15/02

(52) U.S. Cl. 29/889.2; 29/889.721

(57) ABSTRACT

A method of reducing stress in a turbine bucket having an internal cooling circuit formed by a casting core having laterally extending support pins of square or rectangular cross section includes: (a) redesigning the support pins to have a round cross section; or (b) removing the cross-over holes between adjacent cooling passages.

### BACKGROUND

This invention relates generally to turbine technology and, more specifically, to buckets or blades having internal cooling circuits in the airfoil portions of stage 1 and stage 2 buckets.

Certain manufactured turbine buckets or blades have internal serpentine-shaped cooling circuits that have an air inlet adjacent the radially inner end of the airfoil portion for feeding cooling air to a plurality of radial cooling passages, arranged in a generally serpentine configuration and leading to an air exit apertures along the trailing edge of the airfoil. The casting core that is used to form the internal cooling circuit includes a pair of support pins that connect different pairs of adjacent solid leg portions of the core for strengthening the core. After casting, these pins, which have a square or rectangular cross-sectional shape, form cross-over holes, connecting adjacent cooling passages.

It has been found that the resulting square or rectangular cross-over holes create high stress regions that may result in bucket failure.

### BRIEF SUMMARY OF THE INVENTION

In an exemplary embodiment of the invention, the core support pins are modified to have a round cross section to reduce the stress in the resulting cross-over holes. In an alternative embodiment, the core support pins are eliminated to thereby also eliminate the potential for any stress-induced failure relating to cross-over holes.

Accordingly, in one embodiment, the invention relates to a method of reducing stress in a turbine bucket having an internal cooling circuit formed by a casting core having laterally extending support pins of square or rectangular cross section comprising: (a) redesigning the support pins to have a round cross section; or (b) removing the cross-over holes between adjacent cooling passages.

In another embodiment, the invention relates to A method of reducing stress in a first or second stage turbine bucket having an internal cooling circuit formed by a casting core having at least two laterally extending support pins of square or rectangular cross section comprising: (a) redesigning the support pins to have a round cross section; or (b) removing the cross-over holes between adjacent cooling passages.

The invention will now be described in connection with the drawings identified below.

### BRIEF DESCRIPTION OF THE DRAWINGS

FIG. 1 is a perspective view of a stage 1 gas turbine bucket in accordance with an exemplary embodiment of the invention;

FIG. 2 is a transparent view of a bucket similar to that shown in FIG. 1, illustrating the internal cooling passages with an airfoil portion of the bucket; and

FIG. 3 is a side elevation of a casting core used in the manufacture of the turbine bucket shown in FIG. 2.

### DETAILED DESCRIPTION OF THE INVENTION

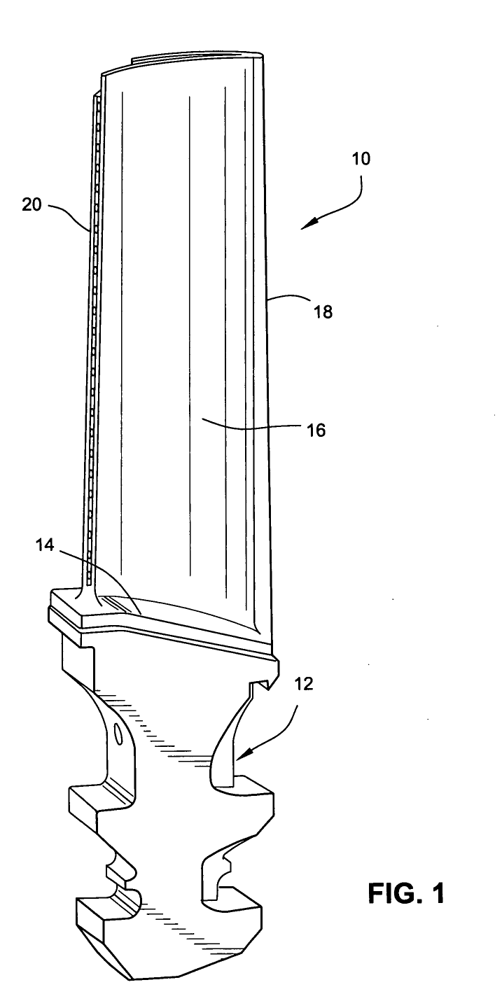

With reference to FIG. 1, a stage 1 gas turbine engine bucket 10 may include a dovetail mounting portion 12, a platform 14 at the radially outer end of the dovetail portion and a radially outwardly extending airfoil portion 16. The airfoil portion is formed with a leading edge 18 and a trailing edge 20.

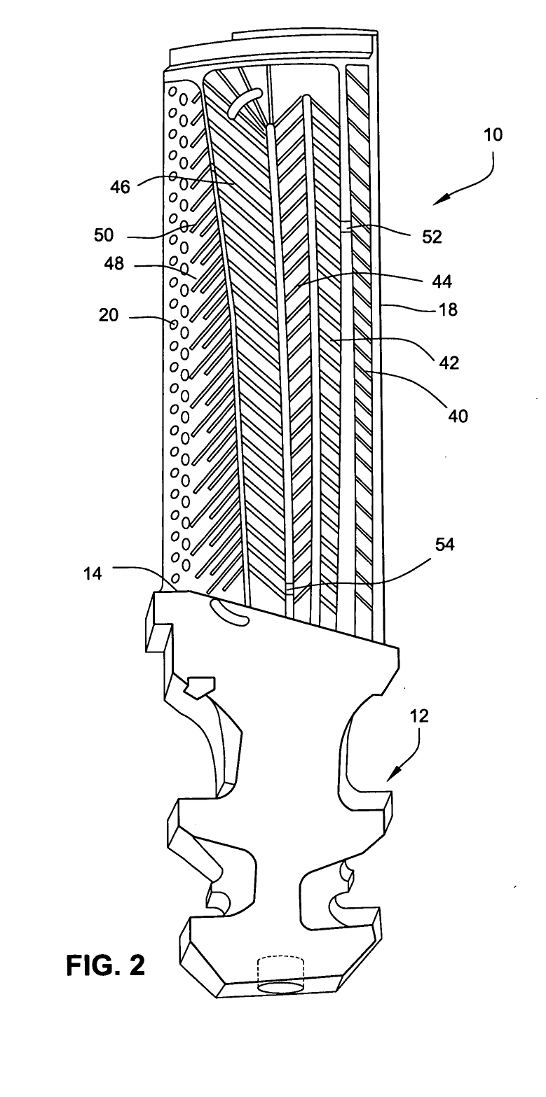

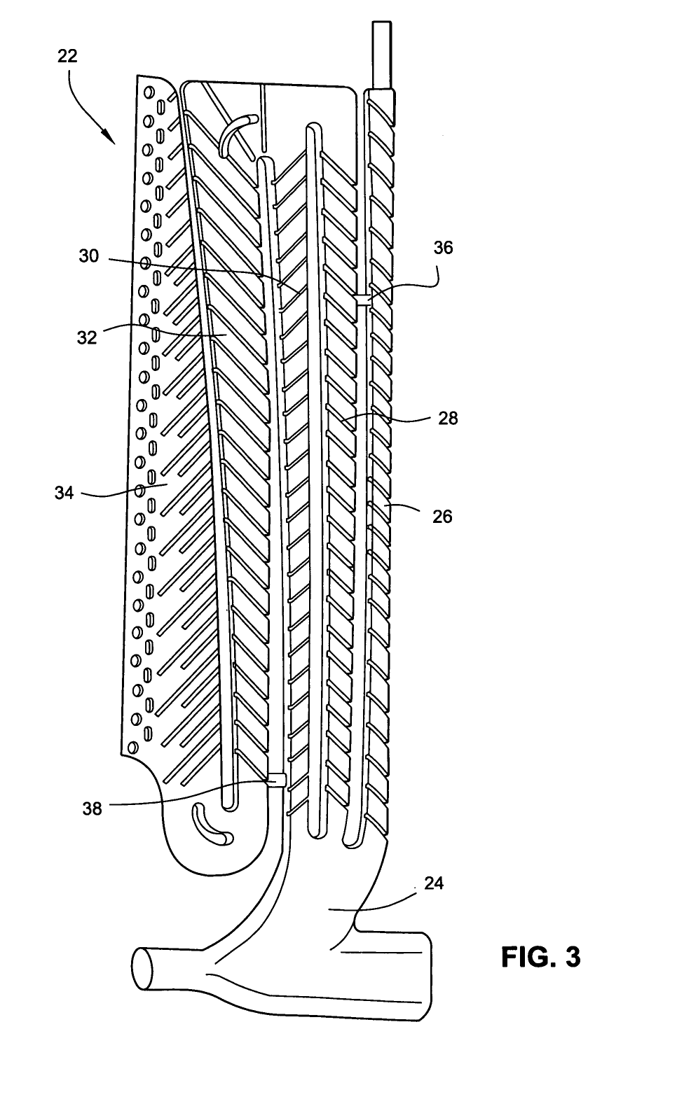

Turning to FIG. 2, a cooling circuit is cast within the interior of the bucket, and specifically within the airfoil portion, that includes a serpentine array of cooling passages that terminate along the trailing edge 20 of the bucket where cooling air exits the airfoil via a plurality of apertures. The cooling circuit is formed with the aid of a casting core of the type shown on FIG. 3. The casting core 22 includes an inlet portion 24 and a plurality of side-by-side (substantially parallel) solid portions (or legs) 26, 28, 30, 32 and 34 which, after casting and after removal of the core material, form the cooling air inlet and cooling air passages, respectively. The empty space between the solid portions of the core thus become solid internal ribs that separate cooling passages within the bucket.

Of significance to this invention, are the core support pins 36 and 38 which are employed primarily to strengthen the core so that it does not break during the casting process. Returning to FIG. 2, the cooling passages formed by the internal casting core are shown at 40, 42, 44, 46 and 48. FIG. 2 also illustrates the cross-over holes 50 and 52 created by the pins 36, 38.

It has been found that the known pins formed with rectangular or square cross sections, create high stress regions which can cause failure at the corners of the bucket cross-over holes.

In an exemplary embodiment of this invention, the pins 36, 38 are made round in cross section, thus also creating the round cross-over holes 52, 54. This change eliminates or at least reduces the high stress regions and minimizes if not eliminates the possibility of casting defects in those regions.

In another exemplary embodiment of the invention, the pins 36 and 38 are simply eliminated, and no cross over holes between cooling passages are established.

The invention here is particularly applicable to Stage 1 and Stage 2 buckets of land-based power-generating gas turbines.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of reducing stress in a turbine bucket having an internal cooling circuit formed by a casting core having laterally extending support pins of square or rectangular cross section comprising:
(a) redesigning said support pins to have a round cross section; or
b) removing the cross-over holes between adjacent cooling passages.

2. The method of claim 1 wherein said cooling circuit is located substantially entirely in an airfoil portion of said turbine bucket.

3. The method of claim 2 wherein said core is formed with at least two support pins.

4. The method of claim 1 wherein said casting core includes a serpentine-shaped cooling passage forming portion made up of spaced, substantially parallel legs.

5. The method of claim 4 wherein said casting core includes at least two of said support pins connecting different pairs of adjacent ones of said spaced, substantially parallel legs.

6. The method of claim 1 wherein the turbine bucket is a first-stage bucket.

7. The method of claim 1 wherein the turbine bucket is a second-stage bucket.

8. A method of reducing stress in a first or second stage turbine bucket having an internal cooling circuit formed by a casting core having at least two laterally extending support pins of square or rectangular cross section comprising:
(a) redesigning said support pins to have a round cross section; or
(b) removing the cross-over holes between adjacent cooling passages.
